(19) United States
(12) Patent Application Publication
(10) Pub. No.: US 2017/0119026 A1
(43) Pub. Date: May 4, 2017

(54) ALKALINE ANTIMICROBIAL COMPOSITIONS, METHODS, AND SYSTEMS

(71) Applicant: SAFE FOODS CORPORATION, NORTH LITTLE ROCK, AR (US)

(72) Inventor: Rob Baker, North Little Rock, AR (US)

(73) Assignee: SAFE FOODS CORPORATION, NORTH LITTLE ROCK, AR (US)

(21) Appl. No.: 15/009,768

(22) Filed: Jan. 28, 2016

Related U.S. Application Data
(60) Provisional application No. 62/285,422, filed on Oct. 28, 2015.

(51) Int. Cl. A23L 3/3589; A23L 3/3544; A23L 3/3526

(52) U.S. Cl. CPC A23L 3/3589; A23L 3/3526; A23L 3/3544

(57) ABSTRACT

The present disclosure relates, according to some embodiments, to systems, compositions, and methods for sanitizing a food product with an alkaline antimicrobial composition. For example, the present disclosure relates, in some embodiments, to a composition for sanitizing a food product with regard to at least one microorganism without substantial residue of the composition left on the sanitized food product, the composition comprising (a) at least one quaternary ammonium compound (b) a base, and (c) at least one solubility enhancing agent. The present disclosure also relates to a system for sanitizing a food product, the system comprising a housing, a plurality of work pieces passing through the housing, a conduit for applying an alkaline antimicrobial composition to the work pieces, and a chiller.

### CROSS-REFERENCE TO RELATED APPLICATIONS

This application claims benefit of U.S. Provisional Application Ser. No. 62/285,422, filed on Oct. 28, 2015, the disclosure of which is incorporated herein by reference.

### FIELD OF THE DISCLOSURE

The present disclosure relates, in some embodiments, to alkaline antimicrobial compositions and methods to treat a material (e.g., a food product) at an early stage of processing.

### BACKGROUND OF THE DISCLOSURE

Rendering safe materials for human use or consumption has been a subject of significant interest. Treatment systems and techniques for sanitizing materials with regard to microorganisms that employ anti-microbial agents are ripe for improvement.

### SUMMARY

Accordingly, a need has arisen for improved compositions, systems, and methods that sanitize a material without substantial residue of the antimicrobial composition left on the surface of the material. Thus, the present disclosure relates, according to some embodiments, to compositions and methods for treating materials to maintain or increase efficacy while mitigating the impact of residue and product surface conditions. A sanitized food product may be referenced for illustration of a material that may be sanitized. For example, a composition may be configured to sanitize a food product with regard to at least one microorganism without substantial residue of the composition left on the sanitized food product. A composition (e.g., an aqueous composition) may comprise at least one quaternary ammonium compound, a base, and at least one solubility enhancing agent. A solubility enhancing agent may comprise a solubilizer, an emulsifier, or a combination thereof. A quaternary ammonium compound may comprise a structure according to Formula I:

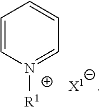

R¹ may be a methyl, ethyl, propyl, butyl, pentyl, hexyl, heptyl, octyl, nonyl, decyl, undecyl, dodecyl, tridecyl, tetradecyl, pentadecyl, or hexadecyl group, and X¹ is fluoride, chloride, bromide, or iodide. In some embodiments, a quaternary ammonium compound may comprise a structure according to Formula II:

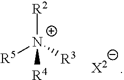

R², R³, R⁴, R⁵ of Formula II may, in some embodiments, each independently be a methyl, ethyl, propyl, butyl, pentyl, hexyl, heptyl, octyl, nonyl, decyl, undecyl, dodecyl, tridecyl, tetradecyl, pentadecyl, or hexadecyl group. X² of Formula II may be fluoride, chloride, bromide, or iodide. In some embodiments, a composition comprising at least one quaternary ammonium compound, may comprise a quaternary ammonium compound according to Formula I, a quaternary ammonium compound according to Formula II, or combinations thereof. In some embodiments, a base may comprise lithium hydroxide, sodium hydroxide, potassium hydroxide, or a combination thereof. An alkaline pH may be about 9.5 to about 12. In some embodiments, a solubility enhancing agent may be propylene glycol, glycerol, or a combination thereof. In some embodiments, a solubility enhancing agent may be propylene glycol. In some embodiments, a solubility enhancing agent may be glycerol. In some embodiments, a solubility enhancing agent is present at a concentration of about 0.1 equivalent of the concentration of the at least one quaternary ammonium compound to about 6 equivalents of the concentration of the at least one quaternary ammonium compound. In some embodiments, the concentration of a solubility enhancing agent may comprise about 1.5 equivalent of the concentration of the at least one quaternary ammonium compound. For example, in some embodiments, the concentration of a solubility enhancing agent may comprise about 0.000001% by weight to about 60% by weight. In some embodiments the antimicrobial composition may comprise Cecure®. In some embodiments, Cecure® may comprise cetylpyridinium chloride, propylene glycol, and water. In some embodiments, the concentration of propylene glycol in Cecure® may be about 1.5 equivalents of the concentration of cetylpyridinium chloride. When contacted with an alkaline antimicrobial composition, a food product and/or the composition may have, in some embodiments, a temperature ≧75° F. (e.g., about 80° F. to about 120° F.). In some embodiments, a composition may comprise at least one quaternary ammonium compound present at a concentration of about 0.000001% by weight to about 10% by weight. A composition may comprise at least one quaternary ammonium compound comprising a concentration, the concentration comprising about 0.32% by weight, about 0.5% by weight, or about 0.55% by weight. In some embodiments, an alkaline pH may be about 10.2 to about 10.8. In some embodiments, a composition may sanitize a material with regard to one or more microorganisms that adversely impact the health or safety of an individual who may use or consume the material including, for example, Salmonella and/or Campylobacter. A food product may comprise poultry, pork, beef, seafood, a fruit, and a vegetable, or a combination thereof. In some embodiments a composition may be reconstituted from an antimicrobial stock solution. In some embodiments, an antimicrobial stock solution may comprise at least one quaternary ammonium compound and/or at least one solubility enhancing agent at concentrations higher than a target working concentration (e.g., about 5×, about 10×, 20×, and/or about 50× more concentrated than the target working concentration). In some embodiments, a quaternary ammonium compound may be present in the antimicrobial stock solution at a concentration of approximately 40% by weight. In some embodiments, a quaternary ammonium compound may be present in an antimicrobial stock solution at a concentration of approximately 30% by weight. In some embodiments, a quaternary ammonium compound may be present in an antimicrobial stock solution at a concentration of approximately 20% by weight. In some embodiments, a quaternary ammonium compound may be present in an antimicrobial stock solution at a concentration of approximately 10% by weight. In some embodiments, a quaternary ammonium compound may be present in an antimicrobial stock solution at a concentration of approximately 5% by weight.

In some embodiments, the present disclosure relates to a method for processing a food product, the method comprising sanitizing a food product with regard to at least one microorganism. In some embodiments, sanitizing a food product with regard to at least one microorganism may comprise contacting the food product with an alkaline antimicrobial composition with both the food product and the composition at a temperature ≧75° F. before the food product enters a chiller, and separating the alkaline antimicrobial composition from the food product to form a sanitized food product. A sanitized food product may be substantially free of alkaline antimicrobial composition residue. In some embodiments, substantially free of alkaline antimicrobial composition residue may comprise a residue of ≦about 32 ppm. In some embodiments, substantially free of alkaline antimicrobial composition residue may comprise a residue of less than or equal to about 25 ppm. In some embodiments, substantially free of alkaline antimicrobial composition residue may comprise a residue of less than or equal to a about 15 ppm. In some embodiments, substantially free of alkaline antimicrobial composition residue may comprise a residue of less than or equal to about 8 ppm. In some embodiments, substantially free of alkaline antimicrobial composition residue may comprise a residue of less than or equal to about 5 ppm. In some embodiments, substantially free of alkaline antimicrobial composition residue may comprise a residue of less than or equal to about 3 ppm. In some embodiments, substantially free of alkaline antimicrobial composition residue may comprise a residue of less than or equal to about 1 ppm. The alkaline antimicrobial composition may comprise at least one quaternary ammonium compound, at least one solubility enhancing agent, an alkaline solution. an alkaline solution may comprise water, lithium hydroxide, sodium hydroxide, potassium hydroxide, or a combination thereof. The at least one microorganism may comprise Salmonella, Campylobacter, or combinations thereof. In some embodiments, the at least one solubility enhancing agent may comprise propylene glycol, glycerol, or a combination thereof. An alkaline solution pH may be about 9.5 to about 12. A composition (e.g., an aqueous composition) for use in sanitizing a material may comprise at least one quaternary ammonium compound, a base, and at least one solubility enhancing agent. A quaternary ammonium compound may comprise a structure according to Formula I:

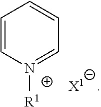

R¹ may be a methyl, ethyl, propyl, butyl, pentyl, hexyl, heptyl, octyl, nonyl, decyl, undecyl, dodecyl, tridecyl, tetradecyl, pentadecyl, or hexadecyl group, and X¹ is fluoride, chloride, bromide, or iodide. In some embodiments, a quaternary ammonium compound may comprise a structure according to Formula II:

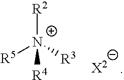

R², R³, R⁴, R⁵ of Formula II may, in some embodiments, each independently be a methyl, ethyl, propyl, butyl, pentyl, hexyl, heptyl, octyl, nonyl, decyl, undecyl, dodecyl, tridecyl, tetradecyl, pentadecyl, or hexadecyl group. X² of Formula II may be fluoride, chloride, bromide, or iodide. In some embodiments, a composition comprising at least one quaternary ammonium compound, may comprise a quaternary ammonium compound according to Formula I, a quaternary ammonium compound according to Formula II, or combinations thereof. In some embodiments, a method may sanitize a material with regard to one or more microorganisms that adversely impact the health or safety of an individual who may use or consume the material including, for example, Salmonella and/or Campylobacter. In some embodiments, the method may comprise the at least one quaternary compound present at a concentration, the concentration comprising about 0.000001% by weight to about 5% by weight. In some embodiments, the method comprises a food product, the food product comprising poultry, pork, beef, seafood, a fruit, and a vegetable, or a combination thereof. When contacted with an alkaline antimicrobial composition, a food product and/or the composition may have, in some embodiments, a temperature ≧75° F. (e.g., about 80° F. to about 120° F.). In some embodiments, an alkaline solution pH may be about 10.2 to about 10.8. In some embodiments, a solubility enhancing agent may comprise propylene glycol, wherein the at least one solubility enhancing agent may comprise a concentration of about 1.5 equivalents of the at least one quaternary ammonium compound. The at least one quaternary ammonium compound may comprise a concentration, the concentration comprising about 0.32% by weight, about 0.5% by weight, or about 0.55% by weight. In some embodiments an alkaline antimicrobial composition may be reconstituted from an antimicrobial stock solution. In some embodiments, an antimicrobial stock solution may comprise at least one quaternary ammonium compound, at least one solubility enhancing agent, or a combination thereof.

The present disclosure relates, according to some embodiments, to a system for sanitizing a food product with regard to at least one microorganism, the system comprising a housing, a plurality of work pieces passing through the housing, a conduit disposed within the housing for applying an alkaline antimicrobial composition to the work pieces, a rinse configured to apply a rinse solution to a food product, and a chiller configured to reduce the temperature of a food product following application of the alkaline antimicrobial composition. The alkaline antimicrobial composition may comprise at least one quaternary ammonium compound, a base, and at least one quaternary ammonium compound. In some embodiments, the system may have at least one quaternary ammonium compound, the at least one quaternary ammonium compound comprises a structure according to Formula I:

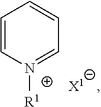

wherein R¹ is a methyl, ethyl, propyl, butyl, pentyl, hexyl, heptyl, octyl, nonyl, decyl, undecyl, dodecyl, tridecyl, tetradecyl, pentadecyl, or hexadecyl group, and X¹ is a fluoride, chloride, bromide, or iodide. In some embodiments, the system may have at least one quaternary ammonium compound, the at least one quaternary ammonium compound comprises a structure according to Formula II:

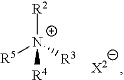

wherein R², R³, R⁴, R⁵ are each independently a methyl, ethyl, propyl, butyl, pentyl, hexyl, heptyl, octyl, nonyl, decyl, undecyl, dodecyl, tridecyl, tetradecyl, pentadecyl, or hexadecyl group, and X² is a fluoride, chloride, bromide, or iodide. In some embodiments, the system may have at least one quaternary ammonium compound, the at least one quaternary ammonium compound comprises a structure according to Formula I, Formula II, or combinations thereof. In some embodiments, the at least one quaternary ammonium compound may comprise a concentration, the concentration comprising about 0.32% by weight, about 0.5% by weight, or about 0.55% by weight. In some embodiments, the alkaline antimicrobial composition may have an alkaline pH on the food product, while leaving the sanitized food product substantially free of the alkaline antimicrobial composition residue. The base may comprise lithium hydroxide, sodium hydroxide, potassium hydroxide, or combinations thereof. The pH may be about 9.5 to about 12. In some embodiments, the system may have at least one solubility enhancing agent comprising propylene glycol, glycerol, or a combination thereof, wherein the at least one solubility enhancing agent is present at a concentration of about 0.1 equivalents of the at least one quaternary ammonium compound to about 6 equivalents of the at least one quaternary ammonium compound. In some embodiments, the food product is at a temperature of more than or equal to about 75° F. In some embodiments, the temperature about 80° F. to about 120° F. The at least one quaternary compound may be present at a concentration of about 0.000001% by weight to about 5% by weight. A system, in some embodiments, may comprise a food product, the food product comprising poultry, pork, beef, seafood, a fruit, and a vegetable, or a combination thereof. In some embodiments an alkaline antimicrobial composition may be reconstituted from an antimicrobial stock solution. In some embodiments, an antimicrobial stock solution may comprise at least one quaternary ammonium compound, at least one solubility enhancing agent, or a combination thereof.

### BRIEF DESCRIPTION OF THE DRAWINGS

Some embodiments of the disclosure may be understood by referring, in part, to the present disclosure and the accompanying drawings, wherein:

FIG. 1 illustrates a food product treatment system according to a specific example embodiment of the disclosure; and

FIG. 2 illustrates a food product treatment flow chart according to a specific example embodiment of the disclosure.

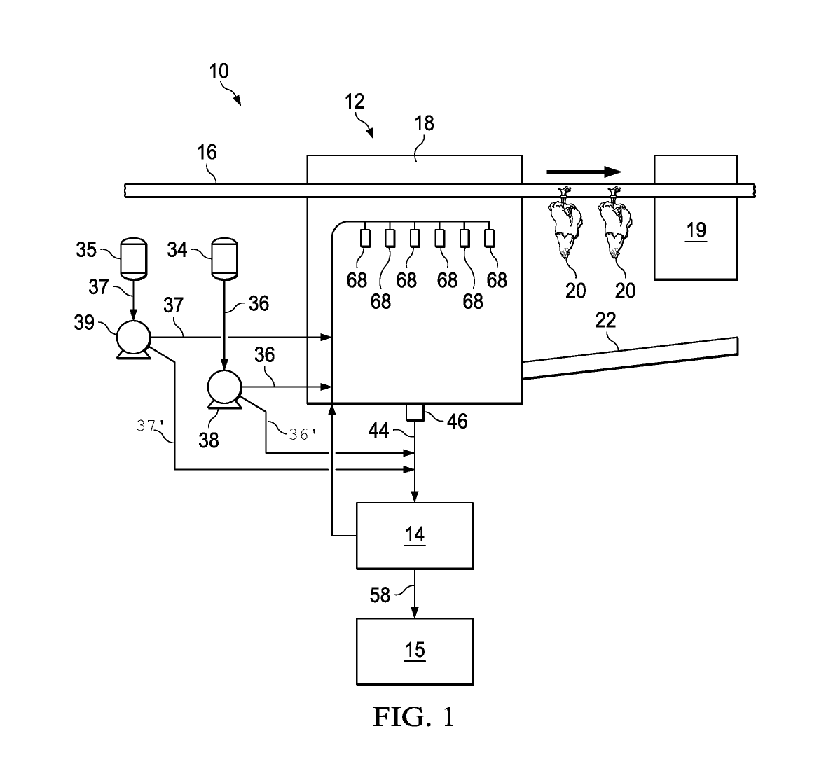

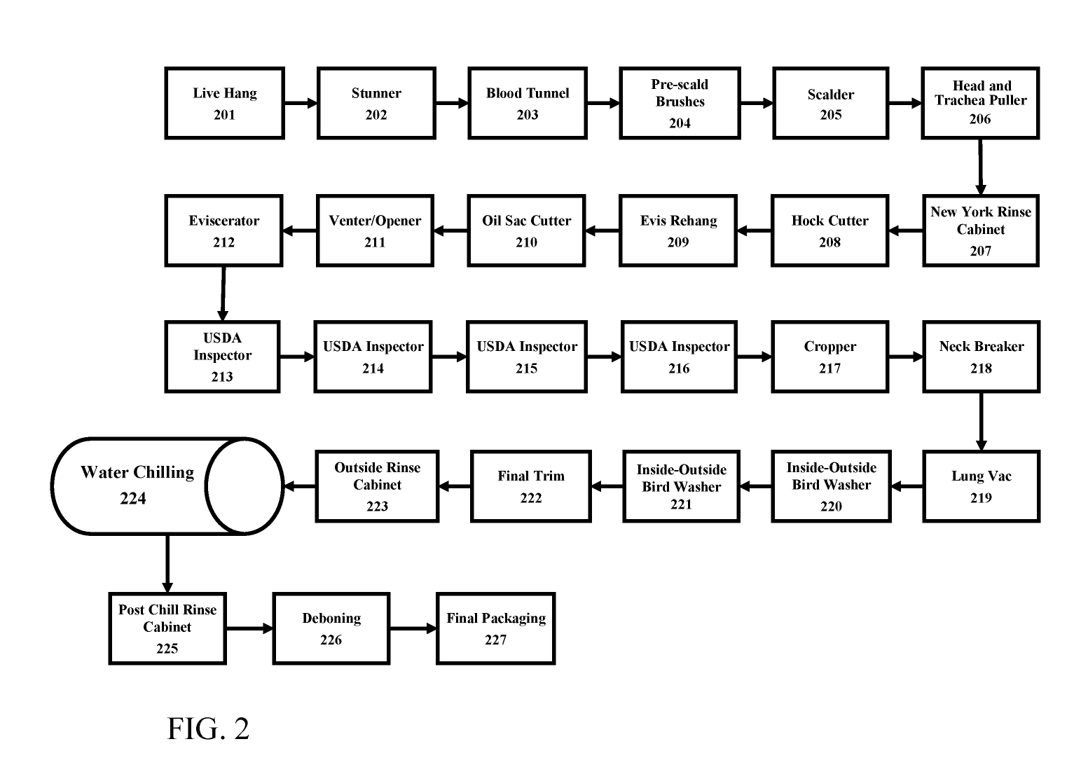

TABLE 1

| | FIG. 1 | FIG. 2 |
|---|---|---|
| System | 10 | |
| Antimicrobial Application Unit | 12 | |
| Recycle Unit | 14 | |
| Waste Capture Unit | 15 | |
| Conveyor Line | 16 | |
| Housing | 18 | |
| Chiller | 19 | |
| Work Pieces | 20 | |
| Drip Tray | 22 | |
| Supply Tank | 34 | |
| Supply Tank | 35 | |
| Antimicrobial Supply Line | 36 | |
| Antimicrobial Supply Line | 37 | |
| Chemical Feed Pump | 38 | |
| Chemical Feed Pump | 39 | |
| Conduit | 58 | |
| Sprayers | 68 | |
| Live Hang | | 201 |
| Stunner | | 202 |
| Blood Tunnel | | 203 |
| Pre-Scald Brushes | | 204 |
| Scalder | | 205 |
| Head & Trachea Puller | | 206 |
| New York Rinse Cabinet | | 207 |
| Hock Cutter | | 208 |
| Evis Rehang | | 209 |
| Oil Sac Cutter | | 210 |
| Venter/Opener | | 211 |
| Eviscerator | | 212 |
| USDA Inspector | | 213 |
| USDA Inspector | | 214 |
| USDA Inspector | | 215 |
| USDA Inspector | | 216 |
| Cropper | | 217 |
| Neck Breaker | | 218 |
| Lung Vac | | 219 |
| Inside-Outside Bird Washer | | 220 |
| Inside-Outside Bird Washer | | 221 |
| Final Trim | | 222 |
| Outside Rinse Cabinet | | 223 |
| Water Chilling | | 224 |
| Post Chill Rinse Cabinet | | 225 |
| Deboning | | 226 |
| Final Packaging | | 227 |

### DETAILED DESCRIPTION

The present disclosure relates, in some embodiments, to alkaline antimicrobial compositions, systems and methods, and more particularly to the use of quaternary ammonium compounds having an alkaline pH to treat a food product at an early stage of processing, wherein the food product may comprise any substance that can be used or prepared for use as food. In some embodiments, a composition for sanitizing a food product with regard to at least one microorganisms without substantial residue of the composition left on the sanitized food product may comprise a concentration of at least one quaternary ammonium compound, a base, a concentration of at least one solubility enhancing agent, and combinations thereof. In some embodiments, compositions may sanitize food portions cut or derived from larger processed bodies, such as poultry parts and mechanically separated chicken, without leaving substantial residue of the composition left on the sanitized food portions. A substantial amount of residue may comprise an amount of composition that may result in undesirable effects on the food product, the food product consumer, or combinations thereof.

The present disclosure, in some embodiments, may comprise at least one quaternary ammonium compound that may be distinguished on the basis of counterion, concentration of quaternary ammonium compound(s), and/or types of substituents that are attached to the nitrogen. For example, the quaternary ammonium compound may comprise a structure according to Formula I:

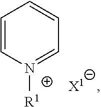

wherein R¹ is a methyl, ethyl, propyl, butyl, pentyl, hexyl, heptyl, octyl, nonyl, decyl, undecyl, dodecyl, tridecyl, tetradecyl, pentadecyl, or hexadecyl group, and X¹, the counterion, is fluoride, chloride, bromide, or iodide. In some embodiments, a quaternary ammonium compound may comprise a structure according to Formula II:

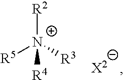

wherein R², R³, R⁴, R⁵ are each independently a methyl, ethyl, propyl, butyl, pentyl, hexyl, heptyl, octyl, nonyl, decyl, undecyl, dodecyl, tridecyl, tetradecyl, pentadecyl, or hexadecyl group, and X², the counterion, is a fluoride, chloride, bromide, or iodide. In some embodiments, a composition comprising at least one quaternary ammonium compound, may comprise quaternary ammonium compounds according to Formula I, Formula II, or combinations thereof. The present disclosure, in some embodiments, may comprise at least one quaternary ammonium compound as previously described at a concentration range, the concentration range comprising about 0.000001% by weight to about 5% by weight. In some embodiments, the concentration of at least one quaternary ammonium compound may comprise about 0.32% by weight, about 0.5% by weight, about 0.55% by weight, or combinations thereof.

In some embodiments, compositions and methods may include an alkaline solution comprising at least one base and an aqueous solvent. According to some embodiments, the base may comprise lithium hydroxide, sodium hydroxide, potassium hydroxide, or combinations thereof. Aqueous solvents may comprise solutions in which the solvent comprises water. In some embodiments, the alkaline solution comprises a pH from about 8 to about 14, from about 9 to about 13, from about 9.5 to about 12, from about 10 to about 11, or about 10.2 to about 10.8. In some embodiments, the alkaline solution comprises a pH of about 10.5.

In some embodiments, increasing the pH of a treatment solution to ranges specified in this disclosure increases water retention by the food product in comparison to pH ranges below about 8, which allows the food product to absorb more antimicrobial into the food product, providing for greater efficacy. In some embodiments, treating a food product, such as a warm poultry carcass, with a quaternary ammonium compound at an elevated pH before the carcass is passed through a chiller and cut into parts improves the microbial quality of interstitial fluids in the carcass and reduces instances of recontamination and cross-contamination that commonly occur when internal microbial contamination is spread during cutting, grinding, or further processing, in comparison to treating a food product with a quaternary ammonium compound at pH ranges below about 8.

The present disclosure, in some embodiments, relates to a composition for sanitizing a food product with regard to at least one microorganism, the composition comprising a concentration of at least one quaternary ammonium compound, an alkaline solution, a concentration of at least one solubility enhancing agent, and combinations thereof, wherein the composition will sanitize a food product with regard to at least one microorganism without substantial residue of the composition left on the sanitized food product. In some embodiments, a solubility enhancing agent comprises propylene glycol, glycerol, or a combination thereof. In some embodiments, a solubility enhancing agent may comprise propylene glycol. A solubility enhancing agent, in some embodiments, may comprise a concentration range of about 0.1 equivalents of the at least one quaternary ammonium compound to about 6 equivalents of the at least one quaternary ammonium compound. In some embodiments, a solubility enhancing agent concentration may comprise about 1.5 equivalents of the at least one quaternary ammonium compound.

The present disclosure relates, in some embodiments, to compositions, systems, or methods comprising quaternary ammonium compounds, an alkaline solution, at least one solubility enhancing agent, wherein the composition is applied to food products at least at room temperature at an intervention point early in the food product processing stages. For example, in some embodiments, the composition or method comprises treating a food product, such as a warm poultry carcass, with a composition comprising at least a quaternary ammonium compound, an alkaline solution, and at least one solubility enhancing agent, or a combination thereof, before the poultry carcass is passed through a chiller and cut into parts. Treatment at this intervention point before the poultry carcass is passed through a chiller and cut into parts may improve the microbial quality of interstitial fluids in the carcass and reduce instances of recontamination and cross-contamination that occur when internal microbial contamination is spread during cutting, grinding, or further processing. The use of a high pH antimicrobial composition application may have the effect of (a) increasing the post-treatment residue of the antimicrobial solution, and (b) temporarily leaving a slick or glossy surface on the treated product. In some embodiments, compositions, systems, or methods comprise an intervention at an early stage of processing, such as prechill, before a water chiller, or before an air chiller, which may allow ample opportunity during the additional processing stages for mitigating, dissipating or eliminating the high pH impact of antimicrobial residues remaining on the treated food product. In some embodiments, the improved efficacy provided may allow downstream antimicrobial interventions to be less robust, for example, allowing the use of lower antimicrobial concentrations. In some embodiments, for example, poultry processing, the intervention point for the high pH treatment is preferably before the chiller and is more preferably used as an online reprocessing treatment stage, wherein the application system used to apply the intervention may take many different forms. In some embodiments, antimicrobial compositions can be applied by methods, the methods comprising manually, by online antimicrobial application equipment, or combinations thereof.

In some embodiments, the elevated pH treatment is preferably followed by a downstream antimicrobial intervention using an antimicrobial at a lower concentration and lower pH, wherein using a quaternary ammonium compound at a low concentration, may be at or below 0.3% by weight, and a low pH, may be within a range from approximately 1.0 to approximately 2.0. In some embodiments, the downstream antimicrobial intervention may be preferably used postchill and is more preferably used near or adjacent the upstream or downstream end of steps in which a food product may be cut into parts or is otherwise separated, ground, or further processed.

Antimicrobials applied to parts or pieces after separation have typically provided results that either lack the desired level of efficacy, create undesirable organoleptic issues, or leave undesirable residue levels on the treated product. These less than satisfactory results on parts applications have led to the exploration of alternate intervention methods, systems, and compositions. The present disclosure relates to improvements in compositions, systems, and methods for sanitizing food products with regard to at least one microorganism while mitigating the impact of residue on the food products. The use of alkaline pH antimicrobial composition application can tend to have the effect of (a) increasing the post-treatment residue of the antimicrobial solution, and (b) temporarily leaving a slick or glossy surface on the treated product. The present disclosure relates, in some embodiments, to alkaline antimicrobial compositions, systems, methods, and more particularly to the use of quaternary ammonium compound compositions having an alkaline pH to treat a food product at an early stage of processing, wherein the remaining antimicrobial residue on the food products comprises less than or equal to about 32 ppm. In some embodiments, the remaining antimicrobial residue on the food products comprises less than or equal to about 25 ppm. In some embodiments, the remaining antimicrobial residue on the food products comprises less than or equal to about 15 ppm. In some embodiments, the remaining antimicrobial residue on the food products comprises less than or equal to about 8 ppm. In some embodiments, the remaining antimicrobial residue on the food products comprises less than or equal to about 5 ppm. In some embodiments, the remaining antimicrobial residue on the food products comprises less than or equal to about 3 ppm. In some embodiments, the remaining antimicrobial residue on the food products comprises less than or equal to about 1 ppm.

The present disclosure, in some embodiments, relates to a composition, system, or method for sanitizing a food product with regard to at least one microorganism without substantial residue of the antimicrobial composition left on the sanitized food product, wherein the food product is preferably at a temperature from more than or equal to about 75° F. to more than or equal to about 125° F. (e.g., more than or equal to 75° F., more than or equal to 85° F., more than or equal to 95° F., more than or equal to 105° F., more than or equal to 115° F., up to about 125° F., or more than or equal to 125° F.). In some embodiments, for example, in poultry, the increased temperature of the product may provide for more open pores which may allow for better penetration by the antimicrobial.

The present disclosure, in some embodiments, relates to an antimicrobial composition, that may be used to sanitize a food product with regard to at least one microorganism without substantial residue of the antimicrobial composition left on the sanitized food product. In some embodiments, stock solutions of antimicrobial compositions may be composed to reduce the logistical problems that may be associated with transporting antimicrobial compositions, wherein the stock solution of the antimicrobial composition may be reconstituted to yield the antimicrobial composition. In some embodiments, stock solutions of antimicrobial compositions may comprise at least one quaternary ammonium compound and at least one solubility enhancing agent. In some embodiments, adding a base to an antimicrobial solution (e.g., an antimicrobial stock solution) may destabilize the solution. For example, adding a base to an antimicrobial stock solution may compromise the solubility of one or more components, compromise the stability of the composition, result in a discolored mixture, and/or combinations thereof. A composition to reconstitute an antimicrobial composition from an antimicrobial stock solution may comprise water, a base, or a combination thereof. In some embodiments, reconstituting an antimicrobial composition from an antimicrobial stock solution may comprise adding water, adding a base, or adding both water and a base. In some embodiments, reconstituting an antimicrobial composition from an antimicrobial stock solution may comprise adding a base at the end of the reconstitution process.

In some embodiments, the present disclosure relates to a method, system, or composition for sanitizing a food product with regard to at least one microorganism without substantial residue of the antimicrobial composition left on the sanitized food product, wherein the microorganisms comprise Gram positive bacteria, Gram negative bacteria, fungi, protozoa or a combination thereof. In some embodiments, the Gram negative bacteria comprise Salmonella, Campylobacter, Arcobacter, Aeromonas, non-toxin-producing Escherichia, pathogenic toxin-producing Escherichia or a combination thereof. In some embodiments, the Gram positive bacteria comprise Staphylococcus, Bacillus, Listeria, or a combination thereof. In some embodiments, the fungi comprise Aspergillus flavus, Penicillium chrysogenum, or a combination thereof. In some embodiments, the protozoa comprise Entomoeba histolytica. In some embodiments, the present disclosure relates to a composition, system, or method that may reduce the total microbial aerobic plate count, or APC, of the food product to a range comprising about 0.000001 Log 10 CFU/mL to about 1 Log 10 CFU/mL, or about 0.1 Log 10 CFU/mL to about 0.5 Log 10 CFU/mL. In some embodiments, the present the present disclosure relates to a composition or method that may reduce the APC of the food product to about 0.000001 Log 10 CFU/mL. According to some embodiments, the present disclosure relates to a composition, system, or method that may reduce the APC of at least one microorganism, the at least one microorganism comprising Salmonella, Campylobacter, or a combination thereof, to a population range comprising about 0.000001% to about 25%, about 0% to about 10%, and about 0% to about 5% of a previous microorganism APC. In some embodiments, the present disclosure relates to a composition, system, or method that may reduce the APC of at least one microorganism, the at least one microorganism comprising Salmonella, Campylobacter, or a combination thereof, to a population comprising about 0.000001% of a previous population.

### SPECIFIC EXAMPLE EMBODIMENTS

Specific example embodiments of a food product treatment system are illustrated in FIG. 1. Antimicrobial application system 10 of the present disclosure generally comprises an antimicrobial application unit 12 and a recycle unit 14, and may include a capture unit 15. Antimicrobial application unit 12 may take any number of configurations. In some embodiments, conveyor 16 passes through a housing 18 for moving work pieces 20, such as raw poultry, through housing 18. A drip tray 22 extends downstream of housing 18, disposed below conveyor 16 and work pieces 20 carried thereby. It is of course understood that antimicrobial application unit 12 is not limited to those embodiments or to spray application systems in general. Antimicrobial application unit 12 may apply a composition such as an antimicrobial composition to any number of different kinds and types of work pieces 20 in any number of different ways. In some embodiments, applicators 68 may comprise sprayers, misters, foggers, and combinations thereof. Methods of applications used by such an application unit 12 may include but are not limited to spraying, misting, fogging, immersing, pouring, dripping, and combinations thereof. It is understood that system 10 may be used to treat a wide variety of different work pieces 20, including but not limited to meat, poultry, fish, fresh and salt water seafood, a fruit, a vegetable, other foodstuffs, animals, food packaging, and items and surfaces related to food or food processing. It is also understood that work pieces 20 may be live, dead, raw, hide-on, carcass, pieces, cooked, prepared, processed, partially processed, ready to eat, or ready to cook. It is further understood that system 10 may be used to treat work pieces 20 completely unrelated to food or food processing items. Conveyor 16 may also transport work pieces 20 from the antimicrobial application unit to chiller 19.

Recycle unit 14 dilutes a concentrated antimicrobial composition or solution to obtain a dilute antimicrobial composition or solution and provides the dilute antimicrobial solution to antimicrobial application unit 12. An antimicrobial source, such as a supply tank 34, may be connected to housing 18 via antimicrobial supply line or conduit 36 and/or return line 44 via antimicrobial supply line or conduit 36′. An antimicrobial source, such as a supply tank 35, may be connected to housing 18 via antimicrobial supply line or conduit 37 and/or return line 44 via antimicrobial supply line or conduit 37′. Multiple return lines 44 may be used to connect multiple antimicrobial application units 12 to recycle unit 14. A conduit 58 may be used to connect recycle unit 14 to capture unit 15. Filter 46 is disposed in housing 18 or in return line 44. Filter 46 is preferably a wire mesh filter, such as a 100 mesh filter, sized to capture visible particulate matter in the effluent from antimicrobial application unit 12. Visible particulate matter in the effluent will typically be minimal because of the upstream washing that will typically be performed on work pieces 20.

Specific example embodiments of a food product treatment flow chart are illustrated in FIG. 2. In some embodiments, for example, a poultry food product treatment process may comprise stages, the stages may begin with live hang 201 and may be followed by stunner 202, which may be followed by a blood tunnel, which may then be followed by pre-scald brushes 204. In some embodiments, the bird brushes with 50 ppm chlorine gas to remove fecal matter prior to going to scalder 205, which may be followed by the head and trachea puller 206, which may be followed by New York rinse cabinet 207, and then hock cutter 208. After hock cutter 208, food products may go through additional stages, the additional stages comprising the evis rehang 209, then oil sac cutter 210, then venter/opener 211, and then eviscerator 212. As shown, additional stages may comprise USDA inspector 213, USDA inspector 214, USDA inspector 215, and USDA inspector 216, which may all be identical USDA inspectors or combinations of different USDA inspectors. Additional stages of the food product treatment process comprise cropper 217, neck breaker 218, lung vac 219, inside-outside bird washer 220, and inside-outside bird washer 221. In some embodiments, additional stages of the food product treatment process comprise final trim 222, outside rinse cabinet 223, water chilling 224, post chill rinse cabinet 225, deboning 226, and final packaging 227. It is of course understood that the food product treatment process stages may be arranged in any order as is needed for various food products. In addition, it is understood that the stages may be amended, reduced in number, augmented in number to conform to the needs associated with treating a wide variety of food products, wherein the food product comprises poultry, pork, beef, seafood, a fruit, a vegetable, or a combination thereof.

As will be understood by those skilled in the art who have the benefit of the instant disclosure, other equivalent or alternative compositions, systems, and methods for sanitizing a food product with regard to at least one microorganism without substantial residue on the composition left on the sanitized food product can be envisioned without departing from the description contained herein. Accordingly, the manner of carrying out the disclosure as shown and described is to be construed as illustrative only.

Persons skilled in the art may make various changes in the shape, size, number, and/or arrangement of parts without departing from the scope of the instant disclosure. For example, the types, concentration(s) and number of quaternary ammonium compounds may be varied. In some embodiments, alkaline solutions may be interchangeable. Interchangeability may allow solubility enhancing agents to be custom adjusted (e.g., by concentration(s), number of solubility enhancing agents, identity of solubility enhancing agents). In addition, applications of methods, systems, and compositions disclosed herein may be used for treating a wide variety of food products, wherein the food product comprises poultry, pork, beef, seafood, a fruit, a vegetable, or a combination thereof. In addition, the methods, systems, and compositions disclosed herein may be scaled up (e.g., to be used for large scale farming) or down (e.g., to be used for individual or parts of food products) to suit the needs and/or desires of a practitioner. Each disclosed method and method step may be performed in association with any other disclosed method or method step and in any order according to some embodiments. Where the verb “may” appears, it is intended to convey an optional and/or permissive condition, but its use is not intended to suggest any lack of operability unless otherwise indicated. Where open terms such as “having” or “comprising” are used, one of ordinary skill in the art having the benefit of the instant disclosure will appreciate that the disclosed features or steps optionally may be combined with additional features or steps. Such option may not be exercised and, indeed, in some embodiments, disclosed systems, compositions, apparatuses, and/or methods may exclude any other features or steps beyond those disclosed herein. Elements, compositions, devices, systems, methods, and method steps not recited may be included or excluded as desired or required. Persons skilled in the art may make various changes in methods of preparing and using a composition, device, and/or system of the disclosure. For example, a composition, device, and/or system may be prepared and or used as appropriate for animal and/or human use (e.g., with regard to sanitary, infectivity, safety, toxicity, biometric, and other considerations).

Also, where ranges have been provided, the disclosed endpoints may be treated as exact and/or approximations as desired or demanded by the particular embodiment. Where the endpoints are approximate, the degree of flexibility may vary in proportion to the order of magnitude of the range. For example, on one hand, a range endpoint of about 50 in the context of a range of about 5 to about 50 may include 50.5, but not 52.5 or 55 and, on the other hand, a range endpoint of about 50 in the context of a range of about 0.5 to about 50 may include 55, but not 60 or 75. In addition, it may be desirable, in some embodiments, to mix and match range endpoints. Also, in some embodiments, each figure disclosed (e.g., in one or more of the examples, tables, and/or drawings) may form the basis of a range (e.g., depicted value +/− about 10%, depicted value +/− about 50%, depicted value +/− about 100%) and/or a range endpoint. With respect to the former, a value of 50 depicted in an example, table, and/or drawing may form the basis of a range of, for example, about 45 to about 55, about 25 to about 100, and/or about 0 to about 100. Disclosed percentages are weight percentages except where indicated otherwise.

All or a portion of a device and/or system for sanitizing food products with regard to at least one microorganism without substantial residue of antimicrobial composition left on the sanitized food product may be configured and arranged to be disposable, serviceable, interchangeable, and/or replaceable. These equivalents and alternatives along with obvious changes and modifications are intended to be included within the scope of the present disclosure. Accordingly, the foregoing disclosure is intended to be illustrative, but not limiting, of the scope of the disclosure as illustrated by the appended claims.

The title, abstract, background, and headings are provided in compliance with regulations and/or for the convenience of the reader. They include no admissions as to the scope and content of prior art and no limitations applicable to all disclosed embodiments.

### EXAMPLES

Some specific example embodiments of the disclosure may be illustrated by one or more of the examples provided herein. The examples discuss using the methods, compositions, and systems in the context of poultry processing, but it is understood that the methods, compositions, and systems disclosed herein may be used for treating a wide variety of food products comprising poultry, pork, beef, seafood, a fruit, a vegetable, or a combination thereof. The following examples are provided to illustrate particular embodiments of the disclosure and are not intended as limiting the scope of the disclosure. Of course, quantitative information is included by way of example only and is not intended as a limitation as to the scope of the disclosure. Accordingly, it is appropriate that the disclosure be construed broadly and in a manner consistent with the scope of the contents of the specification.

### Example 1: Comparing Neutral to High pH Antimicrobial Compositions

In a first example, ten warm, prechilled poultry carcasses were gathered from a processing line before entering a chiller, antimicrobials were applied manually, and the products were tested for efficacy and residue. Five carcasses were treated with Cecure® brand antimicrobial at a concentration of 0.5% cetylpyridinium chloride, abbreviated as CPC herein, by weight at a neutral pH of approximately 7.5, and five carcasses were treated with Cecure® brand antimicrobial at a concentration of 0.5% CPC by weight at an elevated pH of approximately 11. The treatment consisted of a 5 second dip followed by a 5 second drip time. As seen in Table 2, efficacy and residue testing revealed that increasing the pH provided more than a one log reduction in total APC counts while increasing residue by slightly more than 1 ppm. The samples in all three examples were neutralized with activated carbon prior to microbial analysis.

TABLE 2

| | APC-Log10 | Residue |
|---|---|---|
| | CFU/mL | (ppm) |
| Control (CPC @ 0.50%, pH 7) | 1.08 | 1.01 |
| Treated (CPC @ 0.50%, pH 11) | 0.00 | 2.05 |

### Example 2: Comparing Pre-Chill and Post-Chill Treatments

In the second example, fifteen warm, prechill poultry carcasses were gathered from a processing line before entering a chiller, antimicrobials were applied manually, and the products were tested for efficacy and residue. Five carcasses served as a control group. Five carcasses were treated with Cecure® brand antimicrobial at a concentration of 0.32% CPC by weight at a neutral pH of approximately 7.5, and five carcasses were treated with Cecure® brand antimicrobial at a concentration of 0.32% CPC by weight at an elevated pH of approximately 10. Efficacy testing was also conducted on postchill carcasses for samples treated with the high pH CPC. As seen in Table 3, the high pH CPC treatment provided superior efficacy, even postchill.

TABLE 3

| | APC-Log10 | | |
|---|---|---|---|
| | CFU/mL | Salmonella | Campylobacter |
| Control | 3.95 | 40.0% | 100% |
| Normal CPC | 0.49 | 0.0% | 0.0% |
| High pH CPC | 0.0 | 0.0% | 0.0% |
| High pH Postchill | 0.03 | 0.0% | 0.0% |

### Example 3: Testing Various Intervention Points

In the third example, instead of performing manual dips, the high pH CPC treatment was provided using installed, online CPC application equipment. Caustic, sodium hydroxide, was added intermittently to the recycle tank of a CPC application system to maintain a pH of approximately 10.2 to 10.8 for the CPC solution applied to poultry carcasses passing through the drench system. Twenty warm, prechill poultry carcasses were tested. The control group comprised ten untreated carcasses. Ten carcasses were passed through a CPC drench system to be treated Cecure® brand antimicrobial at a concentration of 0.55% CPC by weight at an elevated pH falling within a range of approximately 10.2 to 10.8. Ten carcasses were passed through a water. The data is seen in Table 4.

TABLE 4

| | APC-Log10 | | | Residue |
|---|---|---|---|---|
| | CFU/mL | Salmonella | Campylobacter | ppm |
| Control | 4.30 | 100% | 100% | |
| High pH CPC | 0.00 | 0.0% | 0.0% | |
| High pH CPC | 0.00 | 0.0% | 0.0% | 1.09 |
| Post water | | | | |
| chill wogs | | | | |
| High pH CPC | 0.00 | 0.0% | 0.0% | 0.76 |
| Post air | | | | |
| chill wogs | | | | |
| High pH CPC | 1.62 | 33% | 33% | 14.0 |
| Debone parts, | | | | |
| water chill | | | | |
| High pH CPC | 2.07 | 44% | 11% | 18.8 |
| Debone parts, | | | | |
| air chill | | | | |

1. A composition for sanitizing a food product with regard to at least one microorganism without substantial residue of the composition left on the sanitized food product, the composition comprising:
at least one quaternary ammonium compound;
a base;
at least one solubility enhancing agent,
wherein the composition has an alkaline pH;
wherein the at least one quaternary ammonium compound comprises:
a structure according to Formula I: 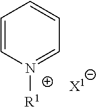
wherein
R¹ is a methyl, ethyl, propyl, butyl, pentyl, hexyl, heptyl, octyl, nonyl, decyl, undecyl, dodecyl, tridecyl, tetradecyl, pentadecyl, or hexadecyl group; and
X¹ is fluoride, chloride, bromide, or iodide; or
a structure according to Formula II: 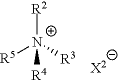
wherein
R², R³, R⁴, R⁵ are each independently a methyl, ethyl, propyl, butyl, pentyl, hexyl, heptyl, octyl, nonyl, decyl, undecyl, dodecyl, tridecyl, tetradecyl, pentadecyl, or hexadecyl group; and
X² is a fluoride, chloride, bromide, or iodide; or
combinations thereof;
wherein the base comprises lithium hydroxide, sodium hydroxide, potassium hydroxide, or combinations thereof;
wherein the alkaline pH is about 9.5 to about 12;
wherein the at least one solubility enhancing agent comprises propylene glycol, glycerol, or a combination thereof;
wherein the at least one solubility enhancing agent is present at a concentration of about 0.1 equivalent of the concentration of the at least one quaternary ammonium compound to about 6 equivalents of the concentration of the at least one quaternary ammonium compound;
wherein the food product is at a temperature ≧75° F.

2. A composition according to claim 1, wherein the at least one quaternary ammonium compound is present at a concentration of about 0.000001% by weight to about 5% by weight.

3. A composition according to claim 1, wherein the at least one quaternary ammonium compound comprises a concentration, the concentration comprising about 0.32% by weight, about 0.5% by weight, or about 0.55% by weight.

4. A composition according to claim 1, wherein the alkaline pH is about 10.2 to about 10.8.

5. A composition according to claim 1, wherein the at least one solubility enhancing agent comprises propylene glycol.

6. A composition according to claim 1, wherein the at least one solubility enhancing agent comprises a concentration of about 0.1 equivalent of the concentration of the at least one quaternary ammonium compound to about 6 equivalents of the concentration of the at least one quaternary ammonium compound.

7. A composition according to claim 1, wherein the temperature is about 80° F. to about 120° F.

8. A composition according to claim 1, wherein the at least one microorganism comprises Salmonella.

9. A composition according to claim 1, wherein the at least one microorganism comprises Campylobacter.

10. A composition according to claim 1, wherein the food product comprises poultry, pork, beef, seafood, a fruit, and a vegetable, or a combination thereof.

11. A composition according to claim 1, wherein the composition is reconstituted from an antimicrobial stock solution.

12. A composition according to claim 11, wherein the antimicrobial stock solution comprises at least one quaternary ammonium compound and at least one solubility enhancing agent.

13. A method for sanitizing a food product with regard to at least one microorganism, the method comprising:
contacting the food product with an alkaline antimicrobial composition at a temperature ≧75° F. before the food product enters a chiller;
separating the alkaline antimicrobial composition from the food product to form a sanitized food product,
wherein the sanitized food product is substantially free of the alkaline antimicrobial composition residue,
wherein the alkaline antimicrobial composition comprises at least one quaternary ammonium compound, at least one solubility enhancing agent, an alkaline solution,
wherein the alkaline solution comprises water, lithium hydroxide, sodium hydroxide, potassium hydroxide, or combination thereof;
wherein the at least one microorganism comprises Salmonella, Campylobacter, or combinations thereof;
wherein the at least one solubility enhancing agent comprises propylene glycol, glycerol, or a combination thereof;
wherein the alkaline solution pH is about 9.5 to about 12;
wherein the at least one quaternary ammonium compound comprises:
a structure according to Formula I: 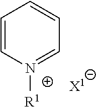
wherein
R¹ is a methyl, ethyl, propyl, butyl, pentyl, hexyl, heptyl, octyl, nonyl, decyl, undecyl, dodecyl, tridecyl, tetradecyl, pentadecyl, or hexadecyl group; and
X¹ is a fluoride, chloride, bromide, or iodide; or
a structure according to Formula II: 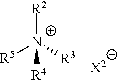
wherein
R², R³, R⁴, R⁵ are each independently a methyl, ethyl, propyl, butyl, pentyl, hexyl, heptyl, octyl, nonyl, decyl, undecyl, dodecyl, tridecyl, tetradecyl, pentadecyl, or hexadecyl group; and
X² is a fluoride, chloride, bromide, or iodide; or
combinations thereof; or a combination thereof.

14. A method according to claim 13, wherein the at least one microorganism comprises Salmonella.

15. A method according to claim 13, wherein the at least one microorganism comprises Campylobacter.

16. A method according to claim 13, wherein the at least one quaternary compound is present at a concentration of about 0.000001% by weight to about 5% by weight.

17. A method according to claim 13, wherein the food product comprises poultry, pork, beef, seafood, a fruit, and a vegetable, or a combination thereof.

18. A method according to claim 13, wherein the temperature is about 80° F. to about 120° F.

19. A method according to claim 13, wherein the alkaline solution pH is about 10.2 to about 10.8.

20. A method according to claim 13, wherein the at least one solubility enhancing agent comprises propylene glycol, glycerol, or a combination thereof, and
wherein the at least one solubility enhancing agent comprises a concentration of about 0.1 equivalent of the concentration of the at least one quaternary ammonium compound to about 6 equivalents of the concentration of the at least one quaternary ammonium compound.

21. A method according to claim 13, wherein the at least one quaternary ammonium compound comprises a concentration, the concentration comprising about 0.32% by weight, about 0.5% by weight, or about 0.55% by weight.

22. A method according to claim 13, wherein the alkaline antimicrobial composition is reconstituted from an antimicrobial stock solution.

23. A method according to claim 22, wherein the antimicrobial stock solution comprises at least one quaternary ammonium compound and at least one solubility enhancing agent.

24. A system for sanitizing a food product with regard to at least one microorganism, the system comprising:
a housing;
a plurality of work pieces passing through the housing;
a conduit disposed within the housing for applying an alkaline antimicrobial composition to the work pieces;
a rinse configured to apply a rinse solution to the work pieces;
a chiller configured to reduce the temperature of the work pieces following application of the alkaline antimicrobial composition;
wherein the alkaline antimicrobial composition comprises:
at least one quaternary ammonium compound;
a base;
at least one solubility enhancing agent,
wherein the at least one quaternary ammonium compound comprises:
a structure according to Formula I: 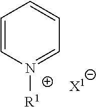
wherein
R¹ is a methyl, ethyl, propyl, butyl, pentyl, hexyl, heptyl, octyl, nonyl, decyl, undecyl, dodecyl, tridecyl, tetradecyl, pentadecyl, or hexadecyl group; and
X¹ is a fluoride, chloride, bromide, or iodide; or
a structure according to Formula II: 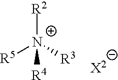
wherein
R², R³, R⁴, R⁵ are each independently a methyl, ethyl, propyl, butyl, pentyl, hexyl, heptyl, octyl, nonyl, decyl, undecyl, dodecyl, tridecyl, tetradecyl, pentadecyl, or hexadecyl group; and
X² is a fluoride, chloride, bromide, or iodide; or
combinations thereof;
wherein the composition has an alkaline pH on the food product while leaving the sanitized food product substantially free of the alkaline antimicrobial composition residue;
wherein the base comprises lithium hydroxide, sodium hydroxide, potassium hydroxide, or combinations thereof;
wherein the alkaline pH is about 9.5 to about 12;
wherein the at least one solubility enhancing agent comprises propylene glycol, glycerol, or a combination thereof;
wherein the at least one solubility enhancing agent is present at a concentration of about 0.1 equivalent of the concentration of the at least one quaternary ammonium compound to about 6 equivalents of the concentration of the at least one quaternary ammonium compound;
wherein the food product is at a temperature ≧75° F.

25. The system according to claim 24, wherein the at least one quaternary compound is present at a concentration of about 0.000001% by weight to about 5% by weight.

26. The system according to claim 24, wherein the temperature is about 80° F. to about 120° F.

27. The system according to claim 24, wherein the food product comprises poultry, pork, beef, seafood, a fruit, and a vegetable, or a combination thereof.

28. The system according to claim 24, wherein the at least one quaternary ammonium compound comprises a concentration, the concentration comprising about 0.32% by weight, about 0.5% by weight, or about 0.55% by weight.

29. The system according to claim 24, wherein the alkaline antimicrobial composition is reconstituted from an antimicrobial stock solution.

30. The system according to claim 29, wherein the antimicrobial stock solution comprises at least one quaternary ammonium compound and at least one solubility enhancing agent.
